(19) United States
(12) Patent Application Publication
(10) Pub. No.: US 2011/0167939 A1
(43) Pub. Date: Jul. 14, 2011

(54) SLIDE HINGE FOR A MOBILE DEVICE

(75) Inventors: Yuchi Chou, Benqaio City (TW); Mark Lin, Taipei (TW)

(73) Assignee: Sony Ericsson Mobile Communications AB, Lund (SE)

(21) Appl. No.: 12/687,568

(22) Filed: Jan. 14, 2010

(51) Int. Cl. F16H 19/04

(52) U.S. Cl. 74/89.17

(57) ABSTRACT

A slide hinge for a mobile device is described.

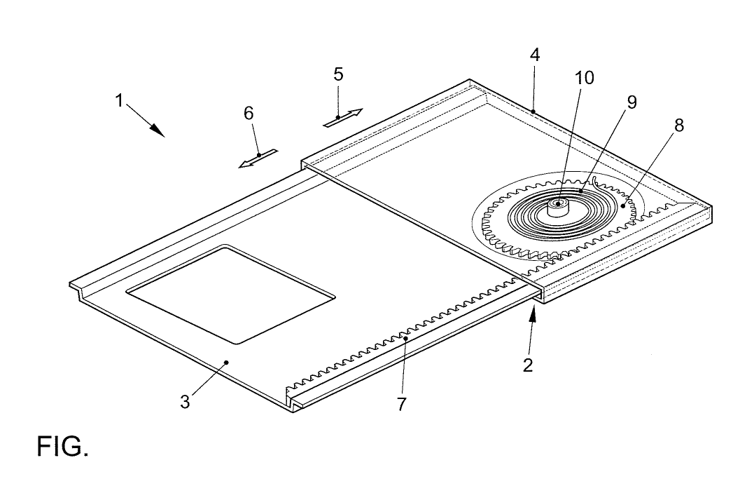

### BACKGROUND OF THE INVENTION

The present invention relates to a slide hinge for a mobile device, especially for a mobile device comprising a display and a keypad, for example a mobile phone, or a portable device, for example a portable computer.

### BRIEF SUMMARY OF THE INVENTION

According to an embodiment, a slide hinge for a mobile device comprises a first section and a second section, wherein the first section and the second section are slideable in relation to each other in a sliding direction. The slide hinge comprises furthermore a linear first gear element which is mounted on the first section, and a second gear element which is rotatably mounted on the second section. A longitudinal direction of the first gear element is arranged in the sliding direction of the slide hinge. The first gear element and the second gear element are engaged with each other such that the second gear element is rotated by the first gear element when the first section and the second section are slideably moved in relation to each other. The slide hinge comprises furthermore a resilient element which is coupled to the second gear element. The resilient element is arranged such that it is tensioned when the second gear element is rotated in a first direction and that the resilient element is relaxed when the second gear element is rotated in a second direction being opposite to the first direction.

Mobile devices, for example a mobile phone, commonly comprise a display and a keypad. For convenience, the display as well as the keypad should be as large as possible. In contrast to this, it is desirable to achieve an overall compact and small design of the device. Therefore, so called slide phones or slider phones have been introduced. A slider phone may comprise a two-part housing with a first part being slideable in relation to a second part. The first part may comprise the display and the second part may comprise the keypad. When the phone is not in use, the second part is pushed below the first part, thus achieving a compact design of the mobile phone. In use, the second part extends from the first part in the sliding direction allowing access to the keypad of the second part.

For such a slider phone the slide stroke distance limits the space for the keypad. In current slider hinge designs a spring or an actuator structure are the major components which limit the slide stroke distance. Typically, in current slide hinge designs, a hair pin spring or actuator are used to keep the slide hinge either in a completely expanded state or in a completely pushed together state. With a width of a phone of approximately 45 mm to 60 mm, it is currently for a hair pin spring or actuator not possible to perform a longer stroke than 50 mm.

In contrast to this the above-described embodiment of a slide hinge is not restricted in stroke distance, as the resilient member does not directly couple the two sections of the slide hinge, but the gear structure comprising the linear first gear element and the rotating second gear element translates the sliding movement into a rotation tensioning and relaxing the resilient element. Therefore, a longer slide stroke distance can be achieved. Furthermore, the design of the above-described embodiment requires less space in the mobile device than the hair pin spring or actuator structure and provides therefore a larger space for the circuitries of the mobile device, especially for a main flexible printed circuit board connecting the two sections of the slide hinge. Furthermore, the above-defined embodiment can be easily adapted for different stroke distances and can therefore be reused without modification in different mobile devices.

According to an embodiment, the first gear element is rod shaped. According to a further embodiment, the second gear element has a circular cross-section.

The first gear element may comprise a rack and the second gear element may comprise a pinion matching to the rack, thus creating a rack and pinion assembly.

According to an embodiment, the resilient element comprises a spiral spring or a volute spring being coaxially attached around a rotation axis of the second gear element. One end of the spring is attached to the second gear element and the other end of the spring is attached to the second section. Thus, when the second gear element is rotated, the spring is tensioned or relaxed depending on the rotation direction of the second gear element.

The first section may comprise a metal sheet and the first gear element may be inserted molded on the metal sheet.

Furthermore, the first gear element may be integrally formed with the first section.

According to an embodiment, the first section and the second section are slideable in relation to each other in the sliding direction for at least 50 mm. Thus, the two housing parts of the mobile device can be moved in the sliding direction for at least 50 mm with respect to each other. This enables for example that a large keypad may be arranged on the second section.

According to an embodiment, the first section comprises a front cover of a housing of the mobile device, and the second section comprises a rear cover of the housing of the mobile device. On the front cover a display may be mounted, and a keypad may be mounted on the rear cover.

According to an embodiment, the slide hinge comprises furthermore a locking mechanism locking the first section and the second section in a tensioned state of the resilient element, and a release mechanism for releasing the locking of the first section and the second section. The locking mechanism may be a snap-in hook mechanism or a snap-fit mechanism locking the first section and the second section when the mobile device is completely pushed together and the resilient element is tensioned. The release mechanism may comprise a user actuatable button for releasing the locking mechanism, upon which the first section and the second section are moved in the sliding direction to an expanded state, driven by the tension of the resilient element. Thus, the mobile device can be automatically expanded or opened by actuating the release mechanism.

The mobile device may comprise a mobile phone, a personal digital assistant, a mobile navigation system, a mobile music player or a mobile computer. Furthermore, the mobile device may comprise any kind of portable device, for example a mobile computer, an ultra mobile personal computer (UMPC) or a midsize notebook or mobile computer.

Although specific features described in the above summary and the following detailed description are described in connection with specific embodiments, it is to be understood that the features of the embodiments described can be combined with each other unless it is noted otherwise.

### BRIEF DESCRIPTION OF THE SEVERAL VIEWS OF THE DRAWING

Hereinafter, exemplary embodiments of the invention will be described with reference to the drawing.

The only FIGURE shows a mobile device with a slide hinge according to an embodiment of the present invention.

### DETAILED DESCRIPTION OF THE INVENTION

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise.

The only FIGURE shows a schematic perspective partial view of a mobile device 1. The mobile device 1 comprises two housing parts which can be moved with respect to each other in sliding directions indicated by the arrows 5 and 6. For allowing the sliding movement of the two housing parts of the mobile device 1, a slide hinge 2 connects the two housing parts. The slide hinge 2 comprises a first section 3 and a second section 4 slideable in relation to each other in the sliding directions indicated by arrows 5 and 6. One of the housing parts of the mobile device 1 may be connected to the first section 3 and the other housing part may be connected to the second section 4. For example, a front cover housing part of the mobile device 1 may be connected to the first section 3 and a rear cover housing part may be connected to the second section 4. However, the front cover housing part may be connected to the second section 4 and the rear cover housing part may be connected to the first section 3.

The slide hinge 2 furthermore comprises a rack 7 and pinion 8 assembly, wherein the rack 7 is mounted on the first section 3 and the pinion 8 is rotatably supported on the second section 4. However, the rack 7 may be mounted on the second section 4 and the pinion 8 may be rotatably mounted on the first section 3. The rack 7 and the pinion 8 are arranged such that the pinion 8 engages with the rack 7. Thus, when the first section 3 is moved with respect to the second section 4 in the sliding directions 5, 6, the pinion 8 is rotated. The slide hinge 2 comprises furthermore a spring 9, for example a spiral spring or a volute spring, which is arranged coaxially to a rotating axis of the pinion 8. The pinion 8 may be mounted on the second section 4 by a rivet 10 serving as the rotating axis for the pinion 8. The spring 9 is also arranged around the rivet 10. One end of the spring 9 may be connected to or engaged with the pinion 8, and the other end of the spring may be attached to the rivet 10. When the pinion 8 is rotated, the tension of the spring 9 is increased or decreased depending on the rotating direction of the pinion 8. When the pinion 8 is rotated in a first direction, the spring 9 may be tensioned, whereas, when rotating the pinion 8 in a second direction opposite to the first direction, the spring 9 may be relaxed. Therefore, when moving the rack 7 in a first direction, for example in the direction of arrow 6, the spring 9 is tensioned, and when moving the rack in a second opposite direction, for example in the direction of arrow 5, the spring 9 is released. Furthermore, in a tensioned state of the spring 9, the rack 7 is urged into the second direction 5.

According to an embodiment of the FIGURE, when the front cover and the rear cover of the mobile phone are pushed together, the spring 9 is tensioned. When the front cover and the rear cover are completely pushed together, the spring 9 is tensioned to its maximum and the front cover and the rear cover are locked to each other by a locking mechanism, for example a snap in mechanism keeping the front cover and the rear cover in the pushed together state. When the locking mechanism is released, for example by pressing down a release mechanism associated with the locking mechanism, the front cover and the rear cover are urged by the tension of the spring 9 into an expanded state, a so called open state of the mobile device.

While exemplary embodiments have been described above, various modifications may be implemented in other embodiments. For example, instead of using a rack and pinion assembly, any other kind of gear assembly may be used, for example a rod and a wheel being engaged via frictional force.

Finally, it is to be understood that all the embodiments described above are considered to be comprised by the present invention as it is defined by the appended claims.

What is claimed is:

1. A slide hinge for a mobile device, comprising:
a first section and a second section slidable in relation to each other in a sliding direction,
a linear first gear element being mounted on the first section, a longitudinal direction of the first gear element being arranged in the sliding direction,
a second gear element being rotatably mounted on the second section, the first gear element and the second gear element being engaged with each other such that the second gear element is rotated by the first gear element when the first section and the second section are slidably moved in relation to each other, and
a resilient element coupled to the second gear element, the resilient element being tensioned when the second gear element is rotated in a first direction, and the resilient element being relaxed when the second gear element is rotated in a second direction opposite to the first direction.

2. The slide hinge according to claim 1, wherein the first gear element is rod-shaped.

3. The slide hinge according to claim 1, wherein the second gear element is circular in cross-section.

4. The slide hinge according to claim 1, wherein the first gear element comprises a rack and the second gear element comprises a pinion.

5. The slide hinge according to claim 1, wherein the resilient element comprises one of a spiral spring and a volute spring, the spring being coaxially attached to a rotation axis of the second gear element.

6. The slide hinge according to claim 1, wherein the first section comprises a metal sheet and the first gear element is insert molded on the metal sheet.

7. The slide hinge according to claim 1, wherein the first gear element is formed integrally with the first section.

8. The slide hinge according to claim 1, wherein the first section and the second section are slidable in relation to each other in the sliding direction for at least 50 mm.

9. The slide hinge according to claim 1, wherein the first section comprises a front cover of a housing of the mobile device and the second section comprises a rear cover of the housing of the mobile device.

10. The slide hinge according to claim 1, wherein the first section comprises a rear cover of a housing of the mobile device and the second section comprises a front cover of the housing of the mobile device.

11. The slide hinge according to claim 1, further comprising a locking mechanism locking the first section and the second section in a tensioned state of the resilient element, and a release mechanism for releasing the locking of the first section and the second section.

12. The slide hinge according to claim 1, wherein the mobile device comprises a device selected from the group comprising a mobile phone, a personal digital assistant, a mobile navigation system, a mobile music player and a mobile computer.
